(19) United States
(12) Patent Application Publication
(10) Pub. No.: US 2009/0205675 A1
(43) Pub. Date: Aug. 20, 2009

(54) Methods and Systems for Using a Laser to Clean Hydrocarbon Transfer Conduits

(76) Inventors: Diptabhas Sarkar, Houston, TX (US); Lewis Norman, Duncan, OK (US); Laurence Abney, Sandnes (NO)

Correspondence Address: JOHN W. WUSTENBERG, P.O. BOX 1431, DUNCAN, OK, 73536, US

(21) Appl. No.: 12/032,829

(22) Filed: Feb. 18, 2008

(51) Int. Cl. B08B 9/027; B08B 7/00

(52) U.S. Cl. 134/1; 134/18; 134/22.11; 134/113

(57) ABSTRACT

An improved method and system for removing blockage from hydrocarbon transfer conduits. An apparatus and methods for cleaning a hydrocarbon transfer conduit is disclosed whereby a laser head is placed in a hydrocarbon transfer conduit to be cleaned and supplied with a laser beam. The laser head applies the laser beam to an area in the hydrocarbon transfer conduit to be cleaned.

### BACKGROUND

Oil and its byproducts play a major role in today's industries. Oil is typically removed from wells and transported through pipelines. Depending on the location of a well and the desired destination of the oil, such pipelines may be on the ground or at the sub-sea level.

The flow of oil through a pipeline can lead to the build up of different substances which tend to impede the fluid flow. For instance, there may be a buildup of scale, paraffin wax, gas hydrates, debris or sand in the pipeline as the oil flows through it. Depending on the nature of the fluid flowing through the pipeline and other surrounding circumstances, one or more of the above deposits may build up in a pipeline.

The scale causing blockage results from the precipitation of chemicals from the brine found in the formation. Furthermore, a reservoir may contain hydrogen sulfide (H₂S) gas, a sulfur-containing chemical may be used during the completion of the wells, or a formation water may contain sulfide ion. In such instances, zinc sulfide (ZnS) or iron sulfide (FeS, Fe₂S₃, FeS₂) scales can form when a zinc bromide brine is exposed to the sulfide ion and where soluble iron exists as a result of corrosion. In addition, there might be sulfates of barium and strontium deposited, when a formation containing barium and strontium ions and injected with sea water, is produced.

Typically, an acid treatment is performed to remove zinc sulfide, iron sulfide and other such scales. In contrast, barium sulfate and strontium sulfate may be removed using alkaline solutions of chelating agents. In either case, a large amount of acids and/or other chemicals is passed through the pipe to be de-scaled to remove the deposits from the inside of the pipeline and allow the passage of fluids there through. However, this method of de-scaling has several disadvantages. One disadvantage of the current de-scaling methods is the need to handle and transport large amounts of corrosive and often hazardous chemicals which are used to de-scale the pipeline. The risks associated with such chemicals is further magnified by the high temperature and pressures in the gas wells and pipelines through which the chemicals are pumped.

Another disadvantage of the current de-scaling methods is that large volumes of chemicals would often have to be passed through a pipeline to be de-scaled. As a result, the process is both time consuming and expensive to carry out. Yet another drawback of the current de-scaling methods is the low efficiency of the de-scaling chemicals when used to clear particularly hard scales such as barium sulfate. This problem is particularly aggravated by the fact that subsea pipelines are typically in cold environments which lower the efficiency of scale dissolution. Additionally, the use of such chemicals which need to be disposed after passage through the pipeline poses significant health, safety and environmental concerns.

Moreover, crude oil contains many different hydrocarbons including paraffin wax. Consequently, paraffin wax depositions often occur when crude oil or other hydrocarbons are produced or transported. Like scales, the formation of paraffin wax obstructs the fluid flow through the pipeline, thereby interfering with production and transportation of hydrocarbons.

One method to prevent the formation of paraffin deposits is to heat the pipelines. However, this method is very expensive and is not feasible for sub-sea pipelines submerged in the cold sea water. Another method for removing the paraffin built up in a pipeline involves “pigging”, whereby a mechanical device is passed through the pipeline which scrapes the inner wall of the pipeline and pushes the paraffin deposits through. One disadvantage of this method is that it is not effective in dealing with a heavy paraffin build up. Specifically, when there is a heavy paraffin build up, as the mechanical device moves, at some point the collection of the dislodged paraffin in front of the device prevents the device from going any further. This will result in a blockage of the pipeline which cannot be remedied by the mechanical device.

Another method for removing paraffin deposits is “hot oiling”. In “hot oiling”, a heated oil is pumped through the pipeline in order to remove the paraffin wax deposits. One drawback of this method is that large volumes of hot oil must be passed through the pipeline making the process expensive. Moreover, this method is not well-suited for removal of deposits from long pipelines, pipelines under water or in other cold conditions. Specifically, as the oil moves through the pipe the heat will dissipate and the oil fails to effectively remove the paraffin deposits. Additionally, the disposal of the hot oil poses significant health, safety and environmental concerns.

In some instances hot water, instead of hot oil, is pumped through the pipeline to remove the paraffin wax deposits. One disadvantage of this method is the formation of undesirable oil/water emulsions resulting from water's inability to dissolve or dilute the paraffin wax. Moreover, using hot water can contribute to the corrosion of the metal pipelines.

Another cause of blockage in pipelines is the formation of gas hydrates where an aqueous phase is inherently present, during the transportation of oil or gases. This is a common problem, especially in regions with low temperatures, during winter season or at the sub-sea level. The low temperatures under such circumstances and the inevitable presence of co-produced water lead to formation of gas hydrates in the pipelines.

One current method of dealing with such gas hydrates is to insulate the pipelines. However such an approach is very expensive. Another method is to pump methanol through the pipeline or use chemical methods such as addition of anti-agglomerates (e.g. kinetic inhibitors or thermodynamic inhibitors). However, to be effective, large quantities of these chemicals must be used making the process expensive. Moreover, these anti-freeze substances are highly flammable adding a safety risk.

As discussed above, many of the current methods of removing unwanted deposits from the pipelines depend upon the existence of a continuous communication through the pipeline. However, as various deposits build up on the pipeline walls the opening for fluid flow becomes smaller and fluid flow may even be completely blocked. Under these circumstances the use of fluids to clean the unwanted deposits becomes highly ineffective. Additionally, parts of the deposits on the pipeline walls may break off causing a blockage of the pipeline. However, the current methods of cleaning the pipeline walls are not well suited for dealing with pipeline blockages. As a result, the blockage may result in a pipeline shut down which can be very expensive for a pipeline operator.

Finally, information about the conditions inside a pipeline can be of great value to an operator. For instance, the operator is often interested to know about the nature and location of deposits formed on the pipeline walls as well as the presence of cracks and other deformities in the pipeline.

### FIGURES

Some specific example embodiments of the disclosure may be understood by referring, in part, to the following description and the accompanying drawings.

FIG. 1 depicts a laser assisted cleaning apparatus in accordance with an exemplary embodiment of the present invention.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### SUMMARY

The present invention is directed to a conduit cleaning method and system. Specifically, the present invention is directed to an improved method and system for removing blockage from hydrocarbon transfer conduits.

In one exemplary embodiment, the present invention is directed to a method of removing deposits from a hydrocarbon transfer conduit comprising the steps of: placing a laser head in a hydrocarbon transfer conduit to be cleaned; supplying the laser head with a laser beam; and, applying the laser beam from the laser head to an area in the hydrocarbon transfer conduit to be cleaned.

In another embodiment, the present invention is directed to a method of removing deposits from a pipe comprising the steps of: placing a heat source in a pipe to be cleaned; placing a liquid in the pipe to be cleaned; supplying the heat source with power; and, applying the power from the heat source to the liquid in an area in the pipe to be cleaned.

In yet another embodiment, the present invention is directed to a hydrocarbon transfer conduit cleaning apparatus comprising: a laser head; a laser source; and, an optical fiber communicatively coupling the laser head and the laser source; wherein the laser head is placed in a hydrocarbon transfer conduit to be cleaned.

The features and advantages of the present disclosure will be readily apparent to those skilled in the art upon a reading of the description of exemplary embodiments, which follows.

### DESCRIPTION

The present invention is directed to a conduit cleaning method and system. Specifically, the present invention is directed to an improved method and system for removing blockage from hydrocarbon transfer conduits.

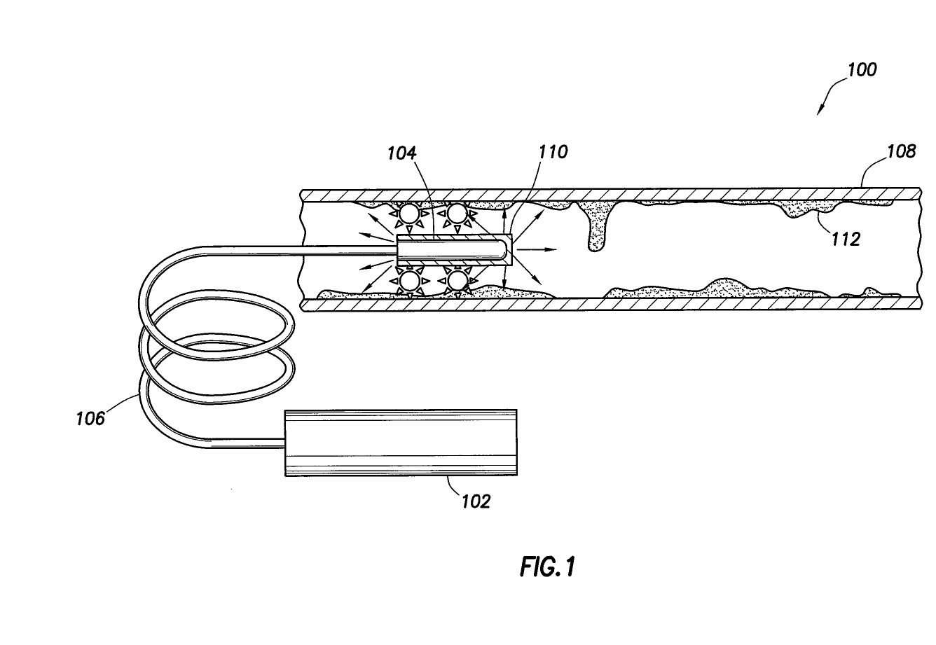

As would be appreciated by those of ordinary skill in the art, hydrocarbons include a variety of naturally occurring organic compounds of carbon and hydrogen, including, but not limited to, oil and natural gas. Hydrocarbons and other fluids may be transferred through conduits which are pipes or channels used to carry fluids. For example, a transfer conduit may be a pipeline. As would be appreciated by those of ordinary skill in the art, a pipeline may be a pipe or a system of pipes designed to carry something such as oil, natural gas, or other hydrocarbons, typically over long distances, above or under the ground. Referring now to FIG. 1, a laser assisted cleaning apparatus in accordance with an exemplary embodiment of the present invention is depicted generally with reference numeral 100. A laser source 102 generates laser beams which are transferred to a laser head 104 through an optical fiber 106 or any other suitable means for transferring the laser beams. As would be appreciated by those of ordinary skill in the art, with the benefit of this disclosure, the optical fiber 106 may be enclosed in a coiled tubing or an umbilical, similar to that used to hold electrical cables, and kept in a reel. Extremely high power laser sources appropriate for this application are available from IPG Photonics, Inc. of Oxford, Mass. Considering the availability of such high power laser sources, there remains sufficient energy for scale removal even after accounting for the attenuation in the optical fibers 106. In one exemplary embodiment, the optical fibers 106 may be part of an umbilical that supplies power used to move the laser head 104 through the pipeline 108. As would be appreciated by those of ordinary skill in the art, with the benefit of this disclosure, the umbilical may include a number of components including, but not limited to, optical fibers, electrical wires and one or more hydraulic lines which may be used to deliver a variety of materials to a desired location in the pipe.

The laser source 102 is placed outside the pipeline 108 on an appropriate platform and is optically coupled to the laser head 104. As a result, the laser beam generated by the laser source 102 can be transferred to any desired location in the pipeline 108 using the laser head 104. The laser head 104 will in turn apply the laser beam to the pipeline 108 walls. In one embodiment, the laser head 104 is also operable to direct the laser towards the front and the back of the laser head 104. Accordingly, the laser assisted cleaning apparatus 100 may be used to clear the scales 112 formed on the pipeline 108 walls as well as any scales formed at any portion of the pipeline 108 cross section.

As would be appreciated by those of ordinary skill in the art, with the benefit of this disclosure, the laser beam applied to the pipeline 108 walls can remove a number of different unwanted deposits including, but not limited to, scales, paraffin wax, gas hydrates, asphaltine, debris, sand or other mechanical blockages.

In one embodiment the laser radiation is used to remove the scale by vaporization. Specifically, a pulsed laser is used to produce electromagnetic radiations having a short pulse width, high pulse repetition rate and a high average power to descale the pipeline by vaporizing molecular layers of the scale with each pulse. The amount of scale removed is controlled by the dwell time of the beam at each location which is a function of the pulse repetition rate and the speed at which the laser head is moved through the pipe. In another embodiment, the laser beam may remove the deposits on the pipeline 108 wall through laser spallation. A high energy pulsed laser is used to create a compressive stress pulse in the deposit layer thereby peeling the deposits off the pipeline 108 wall. The laser spallation process is well known to those of ordinary skill in the art and will not be discussed in detail herein. In other embodiments, the bursts of energy delivered to the pipeline 108 wall by the laser beam will melt any hydrates or paraffin wax deposits on the pipeline 108 wall.

In one embodiment the laser head 104 is placed in a carrier vehicle 110 which is used to transfer the laser head 104 to different locations in the pipeline 108. In an exemplary embodiment, the carrier vehicle 110 may be a pipeline tractor. The carrier vehicle 110 can move to different positions within the pipeline 108 while pulling the optical fiber 106 along, thereby maintaining the optical communication between the laser source 102 and the laser head 104. The carrier vehicle 110 may be placed at a particular position in the pipeline 108 or pass through all or a portion of the pipeline 108 along the pipeline axis. Additionally, the speed of the carrier vehicle 110 may be adjusted depending on factors such as the pulse strength of the laser beam and the amount of deposit 112 present in the pipeline 108. For example, when cleaning a section of the pipeline 108 wall having a thick deposit 112, the operator may slow down the movement of the carrier vehicle 110 in order to increase the amount of time that portion of the pipeline 108 is subjected to the laser beam.

As would be appreciated by those of ordinary skill in the art, with the benefit of this disclosure, the laser head 104 need not be placed in a carrier vehicle and may be moved through the pipeline using a number of different mechanisms, including, but not limited to: (1) pushing the laser head with a self motored pigging device, hydraulically driven pigging device, coiled tubing, or jointed pipe; (2) allowing gravity to move the laser head through the pipeline; or (3) pulling the laser head through the pipeline using a wire or cable.

In one embodiment, a liquid may be placed in the pipe to be cleaned and the heat delivered from a heat source may be used to heat the liquid. The heated liquid will then remove the deposits from the pipe. In one embodiment the heat source may be a laser head and the laser beam which is emitted from the laser head may be used to heat the liquid. Additionally, as would be appreciated by those of ordinary skill in the art, with the benefit of this disclosure, an electrical heater or a microwave heater may be used as the heat source in this embodiment with the operator selecting the type of heat source to be used based on factors such as the amount of heat required to remove the material forming the blockage. In instances when an electrical or microwave heater is utilized, the heat generating unit may be within the pipeline to be cleaned. The power supplied to the electrical or microwave heater is then applied to the liquid.

As would be appreciated by those of ordinary skill in the art, with the benefit of this disclosure, a number of different liquids or mixtures of liquids may be used depending on the material to be removed from the pipe wall and other surrounding circumstances. For instance, in one embodiment, water may be used when the material to be removed comprises gas hydrates. In another embodiment, where the material to be removed comprises paraffin, a mixture of water, surfactant solutions, and other suitable chemicals may be used.

In one exemplary embodiment, the carrier vehicle 110 is equipped with a feedback mechanism (not shown) to monitor the power incident on the pipeline 108 wall and adjust the frequency, pulse width and other properties of the laser at the laser source 102 to optimize the power incident on the pipeline 108 walls. In another embodiment the feedback mechanism is operable to perform a profilometric analysis of pipeline 108 wall surfaces and deposits thereon. The performance of profilometric analysis is known to those of ordinary skill in the art and will not be discussed in detail herein. As would be appreciated by those of ordinary skill in the art, with the benefit of this disclosure, the operator may use the information obtained from the feedback mechanism to modify the performance of the laser head or identify cracks or other deformities in the pipeline 108 walls.

In another exemplary embodiment, the carrier vehicle 110 is equipped with a monitoring device (not shown) to track the progress of the cleaning device 100. In one embodiment, the monitoring device records the reflectance from the pipeline 108 wall as a measure of scale removal. As would be appreciated by those of ordinary skill in the art, with the benefit of this disclosure, due to its luster, pure metal has a higher level of reflectance than scales. As a result, the amount of deposits 112 removed can be tracked by monitoring the reflectance from the pipeline 108 wall with an increased reflectance indicating a reduction in the amount of deposits 112 remaining.

In one exemplary embodiment the carrier vehicle 110 may be equipped to conduct a spectroscopic analysis of effluent gasses and the materials deposited on the pipeline 108 walls. As would be appreciated by those of ordinary skill in the art, with the benefit of this disclosure, in order to conduct spectroscopy of the substances deposited on the pipeline 108 walls, electromagnetic radiations are applied and the reflectance or absorbance of the radiations is analyzed to determine the properties of the deposits. Details of conducting spectroscopy analysis on a substance are known to those of ordinary skill in the art and are not discussed in detail herein.

In one exemplary embodiment, the carrier vehicle 110 is equipped with lenses and other appropriate beam shaping optics that may be used to adjust the properties of the laser beam directed onto the pipeline 108 wall. For instance, in one embodiment, the radiation beam is passed through a series of aligned optical elements such as cylindrical lenses, mirrors or a combination thereof to focus the beam at a desired location. In another embodiment, the radiation beam may first be homogenized to form a beam having a uniform intensity.

As would be appreciated by those of ordinary skill in the art, with the benefit of this disclosure, although the additional equipment is described as being coupled to the carrier vehicle 110, these equipment need not be placed directly on the carrier vehicle and can be otherwise coupled thereto or may be capable of independent navigation through the pipeline. Moreover, as would be appreciated by those of ordinary skill in the art, with the benefit of this disclosure, some of the equipment used in analysis of the conditions inside the pipeline may be placed outside the pipeline and may be communicatively coupled to the equipment inside the pipeline through the optical fibers.

Additionally, in certain exemplary embodiments, the carrier vehicle 110 may be equipped with a pigging mechanism or mechanical scrapper which can assist in removal of the cracked or broken deposits as they are separated from the pipeline 108 wall.

In one exemplary embodiment the laser assisted cleaning apparatus 100 may be utilized to remove a complete blockage in the pipeline. In one embodiment, the unit may first inspect the form and orientation of the blockage at hand. As would be appreciated by those of ordinary skill in the art, with the benefit of this disclosure, a variety of different mechanisms may be used to inspect the blockage. In one embodiment, the inspection may be through the use of video technology, proximity sensors or other non mechanical/tactile sensory devices. A detailed discussion of the operation of such inspection devices is not included herein as it is known to those of ordinary skill in the art. After inspection, the laser head 104 will deliver the laser beam supplied by the laser source 102 to the blockage. In one embodiment, the laser beam would be used to establish a flow path through the blockage in order to allow the use of more traditional deposit removal systems such as treatment chemicals. Alternatively, the laser beam may be used to completely remove the blockage and deposits adhered to the walls of the pipeline 108, thereby clearing the blockage.

In another Exemplary embodiment, the laser assisted cleaning apparatus 100 may be adjusted to provide sufficient power to cut a window in the pipe walls at a desired location. In this embodiment, the carrier vehicle 110 is moved through the pipeline and placed in a location where a window is desired through the pipeline 108. The power delivered by the laser source 102 is adjusted such that the laser head 104 can deliver sufficient power to the pipeline 108 wall to create a window in the pipeline 108.

As would be appreciated by those of ordinary skill in the art, with the benefit of this disclosure, the laser assisted cleaning apparatus 100 of the present invention may be used independently, or in conjunction with other current methods of cleaning deposits in pipelines. For example, in instances of pipeline blockage when the passage of deposit removing fluids through the pipeline proves ineffective, the laser assisted cleaning apparatus 100 of the present invention can be used to apply a laser beam to the materials forming the blockage. The application of the laser beam will remove the blockage providing a path for fluids to flow. The creation of a path for fluid flow permits the use of more traditional deposit removal methods such as the use of treatment chemicals.

In one exemplary embodiment the pipeline to be cleaned may be subjected to de-oiling before the pipeline is cleaned by the laser beam. In this exemplary embodiment, a plug of surfactant solutions can be sent ahead of the laser head to clean the pipeline surface before it is subjected to the laser beam in order to prevent an ignition resulting from the incident laser beam.

Although the present invention is described in the context of oil field applications, as would be appreciated by those of ordinary skill in the art, with the benefit of this disclosure, the present invention may be used for cleaning any conduit that is used for transfer of fluids. For example, the present invention may be used to clean water pipes that have become partially or fully blocked due to water impurities or the like.

Additionally, although the present invention is described in the context of oil pipelines, as would be appreciated by those of ordinary skill in the art, methods and apparatuses in accordance with an embodiment of the present invention may be used in conjunction with any hydrocarbon transfer conduits above the grounds or down hole, such as, for example, in well bores.

Hence, the laser assisted cleaning apparatus of the present invention is capable of operating with great precision, simulating an optical chisel, thereby eliminating the need for using large volumes of hazardous chemicals. Moreover, considering the availability of high power laser sources, the power supplied by the laser source 102 can be increased to efficiently remove hard scales such as barium sulfate. Additionally, the laser assisted cleaning apparatus of the present invention may be equipped with feedback mechanisms and the necessary equipment to analyze the conditions in a pipeline.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain and ordinary meaning unless otherwise explicitly and clearly defined by the patentee.

What is claimed is:

1. A method of removing deposits from a hydrocarbon transfer conduit comprising the steps of:
placing a laser head in a hydrocarbon transfer conduit to be cleaned;
supplying the laser head with a laser beam; and,
applying the laser beam from the laser head to an area in the hydrocarbon transfer conduit to be cleaned.

2. The method of claim 1, wherein the laser beam is supplied to the laser head from a laser source.

3. The method of claim 2, wherein the laser source is optically coupled to the laser head.

4. The method of claim 2, wherein the laser source is placed outside the hydrocarbon transfer conduit.

5. The method of claim 1, wherein the laser head is placed in a carrier vehicle.

6. The method of claim 5, wherein the carrier vehicle operates to transport the laser head in the hydrocarbon transfer conduit.

7. The method of claim 1, wherein the area in the hydrocarbon transfer conduit to be cleaned is a hydrocarbon transfer conduit wall or a portion of a cross section of a hydrocarbon transfer conduit.

8. The method of claim 1, wherein the laser head is operable to direct a laser beam to one of a wall of the hydrocarbon transfer conduit to be cleaned or a portion of a cross section of the hydrocarbon transfer conduit to be cleaned.

9. The method of claim 1, further comprising the step of inspecting a deposit formation in the hydrocarbon transfer conduit before applying the laser beam from the laser head to the area in the hydrocarbon transfer conduit to be cleaned.

10. The method of claim 9, wherein inspecting the deposit formation is conducted using one of a proximity sensor or a video system.

11. The method of claim 1, further comprising conducting a spectroscopic analysis of one of an effluent gas or a deposit formation in the hydrocarbon transfer conduit.

12. The method of claim 1, further comprising conducting a profilometric analysis of a hydrocarbon transfer conduit wall surface.

13. The method of claim 1, wherein a deposit to be removed from the hydrocarbon transfer conduit is a scale, a paraffin, an asphaltine, a gas hydrate or sand.

14. A method of removing deposits from a pipe comprising the steps of:
placing a heat source in a pipe to be cleaned;
placing a liquid in the pipe to be cleaned;
supplying the heat source with power; and,
applying the power from the heat source to the liquid in an area in the pipe to be cleaned.

15. The method of claim 14, wherein the heat source is a laser head, an electrical heater or a microwave heater.

16. The method of claim 15, wherein a laser source supplies the laser head with a laser beam.

17. The method of claim 16, wherein the laser source is placed outside the pipe to be cleaned.

18. The method of claim 16, wherein the laser head and the laser source are communicatively coupled with an optical fiber.

19. The method of claim 16, wherein the laser source is adjustable to provide a laser beam having at least one of a desirable frequency, a desirable amplitude and a desirable power.

20. The method of claim 14, wherein the heat source is coupled to a carrier vehicle.

21. The method of claim 20, wherein a speed of the carrier vehicle is adjustable.

22. The method of claim 14, further comprising the step of monitoring deposit removal with a feedback mechanism.

23. The method of claim 22, wherein the feedback mechanism comprises one of a reflectance sensor, an optical sensor, a temperature sensor, or a video system.

24. A hydrocarbon transfer conduit cleaning apparatus comprising:
a laser head;
a laser source; and,
an optical fiber communicatively coupling the laser head and the laser source;
wherein the laser head is placed in a hydrocarbon transfer conduit to be cleaned.

25. The apparatus of claim 24, wherein a power supplied by the laser head to the hydrocarbon transfer conduit can be sufficiently increased to cut a window in a hydrocarbon transfer conduit wall.
